(19) United States
(12) Patent Application Publication
(10) Pub. No.: US 2010/0325126 A1
(43) Pub. Date: Dec. 23, 2010

(54) RECOMMENDATION BASED ON LOW-RANK APPROXIMATION

(76) Inventors: Shyam S. RAJARAM, Mountain View, CA (US); Martin B. Scholz, San Francisco, CA (US); Rong Pan, Mountain View, CA (US); Rajan Lukose, Oakland, CA (US)

Correspondence Address: HEWLETT-PACKARD COMPANY;Intellectual Property Administration, 3404 E. Harmony Road, Mail Stop 35, FORT COLLINS, CO, 80528, US

(21) Appl. No.: 12/487,254

(22) Filed: Jun. 18, 2009

(51) Int. Cl. G06F 17/30

(52) U.S. Cl. 707/759; 707/805; 707/708; 707/769

(57) ABSTRACT

A system and method for providing personalized recommendations are disclosed herein. A system includes a processor and a software system executed by the processor. The software system provides a recommendation for an item. The recommendation is based on a comparison of a low-rank approximation of a domain matrix to a user profile. The user profile is based, in part, on the low-rank approximation of the domain matrix.

### BACKGROUND

A vast quantity of information is available to users via the internet. As the amount of information increases, various methods of filtering the information presented to users have been developed. Search engines attempt to classify and rank web pages with the goal of presenting only the most relevant web pages in response to a user query. Recommendation systems attempt to identify and suggest specific items that may be of interest to a given user. Recommendation systems are widely used in e-commerce and various other web applications to reduce the amount of information presented to a user. Recommendation systems have been applied to a wide range of subjects, for example, music, movies, news, restaurants, events, sales offerings, etc. Some recommendation systems suggest items based on preferences expressed by a given user and stored descriptions of the various available items, i.e., content-based recommendation. Other recommendation systems, e.g., systems implementing collaborative filtering, suggest items for a given user based on preference information collected from a number of users.

### BRIEF DESCRIPTION OF THE DRAWINGS

For a detailed description of exemplary embodiments of the invention, reference will now be made to the accompanying drawings in which:

FIG. 1 shows a block diagram of an exemplary recommendation system in accordance with various embodiments;

FIG. 2 shows an exemplary comparison of three domain items in accordance with various embodiments;

FIG. 3 shows a block diagram of a recommendation server in accordance with various embodiments; and

FIG. 4 shows a flow diagram for a method for providing recommendations to a user in accordance with various embodiments.

### NOTATION AND NOMENCLATURE

Certain terms are used throughout the following description and claims to refer to particular system components. As one skilled in the art will appreciate, computer companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . .” Also, the term “couple” or “couples” is intended to mean either a physical or logical connection. Thus, if a first device couples to a second device, that connection may be through a direct electrical connection, through an indirect electrical connection via other devices and connections, through an optical electrical connection, through a wireless electrical connection, etc. Further, the term “software” includes any executable code capable of running on a processor, regardless of the media used to store the software. Thus, code stored in memory (e.g., non-volatile memory), and sometimes referred to as “embedded firmware,” is included within the definition of software.

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

A system for providing personalized content to a user may be based on a user profile, i.e., a data record that contains information regarding the user's preferences. Preference information may be derived from the user's browsing history, purchasing history, listening history, or other recorded behavior. However, implementing a recommendation strategy based on exact matching of profile content may unduly restrict the scope of recommendations. For example, recommending music based only on the name of an artist included in a user profile, limits recommendations to only musical selections with which the artist is connected, resulting in limited recommendations. Use of taxonomies to categorize items may provide opportunities to expand recommendations by identifying relationships between items. However, the vast number of items to be categorized makes a comprehensive taxonomy unwieldy. Thus, separate taxonomies for each item domain (e.g., music, movies, etc.) can be advantageous. Similarly, maintaining separate user profiles for each user interest domain may also be advantageous. Even if domain specific user profiles and taxonomies are employed, numerous taxonomies are available (e.g., each web merchant may support its own taxonomy of items for sale) and relating profile and taxonomy data may be difficult.

Embodiments of the present disclosure provide recommendations (i.e., suggestions or proposals) based on user preferences as derived from user activities (e.g., web browsing, music listening, purchasing, etc.) catalogued by the user's computer. For example, an events website can be personalized based on a user's musical tastes as determined by music stored on the user's computer, his music buying history and/or his listening history. Similarly, a web merchant's website can be personalized for a user based on the user's browsing and/or purchasing history across a variety of websites, rather than based solely on the user's past activities on only the merchant's website. Embodiments provide a robust taxonomy based profiling scheme that allows for direct comparison between user profiles and item profiles. As used herein, the term item refers to anything that can be recommended to a user (e.g., products, movies, music, news, etc.).

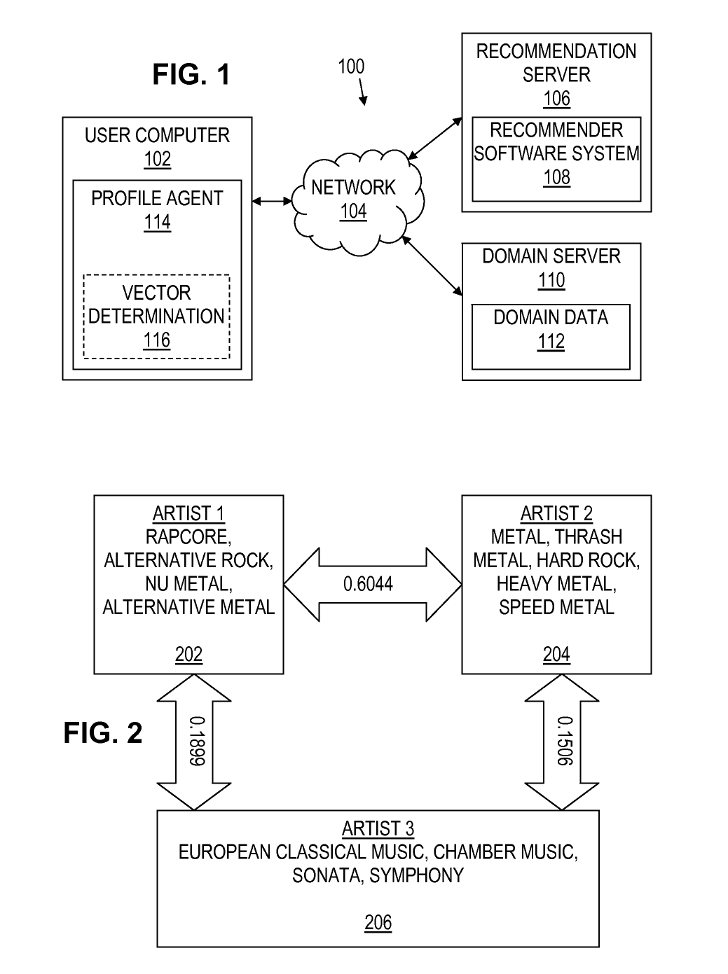

FIG. 1 shows an exemplary recommendation system 100 in accordance with various embodiments. The system 100 includes a user computer 102, a recommendation server 106, and a domain server 110 coupled via a network 104. The network 104 can comprise any combination of networking technologies used to connect computer systems, for example, local area networks, wide area networks, metropolitan area networks, the internet, wireless networking (e.g., IEEE 802.11, etc.), wired networking (e.g., IEEE 802.3, etc.). Each of the user computer 102, recommendation server 106, and domain server 110 include various components such as a processor, memory, a network adapter, user interfaces, etc. In some embodiments, some of the system 100 components may be co-located. For example, the recommendation server 106 and the domain server 110 may be provided by a single computer. In some embodiments, components of the system 100 may be distributed across a plurality of computers. For example, the domain server 110 may be implemented via a multi-computer system. Embodiments encompass any number of computers and components (hardware or software) configured to provide the recommendation system described herein or its equivalent.

The domain server 110 includes the domain data 112. The domain data 112 comprises data set represented as a taxonomy or other representation of a given item domain. For example, in the domain of music the domain data 112 may include information that relates musical artists to musical genres. In some embodiments, the domain data 112 provides current data with regard to the items in the domain allowing the recommendation system 100 to provide personalization based up-to-date information. The domain data 112 can be organized in any manner that allows relationships between items to be derived. For example, the domain data 112 can be organized as a tree, having musical artists represented at leaves of a particular branch, where the branch is a musical genre, or as text strings associating an artist with a genre, etc.

The domain server 110 provides the domain data 112 to the recommendation server 106. The organization of the domain data 112, as provided by the domain server 110, may not allow data 112 to be directly used by the recommendation system 100. For example, the domain data 112 may include excessive redundancy, one illustration of redundancy being inclusion of numerous similar categories in the domain data 112 and lack of information as to the similarities between categories. As a result of such redundancy, similar categories (e.g., different kinds of jazz music) may be considered just as different as more disparate categories (e.g., jazz and heavy metal). The domain data 112 may also exhibit other deficiencies, such as an undesirable amount of labeling inconsistency.

The recommendation server 106 includes a recommender software system 108. The recommender software system 108 performs various functions with regard to providing user recommendations based on similarities between user profiles and item profiles extracted from the domain data 112. In some embodiments, the recommender software system can be included as a component of another system, for example, a search engine component, or as a separate piece of software. The recommender software system 108 receives the domain data 112 provided from the domain server 110 via the network 104, and processes the domain data 112 to generate a compact and robust representation of the domain. The recommender software system 108 extracts the item-category mappings from the domain data 112, and constructs an N×M binary domain matrix A that represents the item-category relationships. For example, a domain matrix A may be constructed wherein:
N is the number of items;
M is the number of categories to which an item may belong; and
A(i,j)=1 indicates that the ith item belongs to the jth category.
   Thus, for example, if a musical artist is an item, the musical artist may belong in one or more categories based on the types or genres of music ascribed to the artist by the domain data 112.

The recommender software system 108 applies a low-rank approximation algorithm to the matrix A. Low-rank approximation is a means of providing a more compact representation of a matrix (via dimension reduction) while limiting loss of information. Thus, a low-rank approximation of the matrix A is derived from and approximates the matrix A with reduced dimensions. Embodiments can apply various low-rank approximation algorithms, for example, singular value decomposition, weighted low-rank approximation, or any other low-rank approximation algorithm known in the art. The result of applying the low-rank approximation algorithm to the matrix A is a k-dimensional vector representation for each category, where k may be chosen to be much smaller than N or M.

The user computer 102 includes a profile agent 114. The user computer 102 is, for example, a personal computer through which a user engages in computer-based activities, such as web-browsing, maintaining a music collection, shopping, etc. The profile agent 114 tracks and records user activities to facilitate construction of one or more user profiles that may be used to provide recommendations. For example, music recorded by various artists and stored on the computer 102, without regard to whether the music was downloaded via the internet or by other means, as well as music searches conducted via the web, visits to artist's websites, etc. may be cataloged by the profile agent 114 to facilitate construction of a music profile for the user of the computer 102. Similarly, movies viewed via the computer 102 whether through the web or otherwise, movie searches, movie website visits, etc, may be cataloged by the profile agent 114 to construct a movie profile for the user. Embodiments may collect user information relevant to any domain for construction of a user profile for that domain.

In some embodiments, the profile agent 114 may be downloaded to the user computer 102 from the recommender software system 108. In some embodiments, the profile agent 114 may be provided to the user computer 102 by a third party agent of the recommendation system 100, or by other means. In some embodiments, the profile agent 114 may be web browser extension component, or a separate software component executing in the background on the user computer 102.

In some embodiments, the profile agent 114 can transfer raw user data to the recommender software system 108. Thus, in the music context for example, artist information, song information, etc. derived from user activities can be transferred from the profile agent 114 to the recommender software system 108. In such embodiments, the user information may be maintained on the recommendation server 106 and used to construct a user profile. Accordingly, the recommender software system 108, can extract from the user data a collection of items and categories in accordance with the items and categories provided via the domain data 112. Based on these categories of user preference and the low-rank approximation computed for the domain matrix a compact user profile is constructed. The user profile can comprise the relevant category vectors of the domain low-rank approximation.

In some embodiments, the profile agent 114 may not transfer raw user data to the recommender software system 108. In such embodiments, the profile agent 114 can include a vector determination module 116. The vector determination module 116 determines a user profile, in terms of the categories and items of the domain matrix and the low-rank approximation of the domain matrix, and transfers the user profile (i.e., a set of user profile vectors) to the recommender software system 108. Such embodiments allow user data, such as browsing history, play lists, etc., to remain private while exporting a user profile that allows the recommendation system 100 to provide recommendations based on the user's preferences.

Similarly, the recommender software system 108 can generate a profile for each item in the domain. An item profile characterizes an item based on the domain categories to which the item belongs and the degree to which the item belongs to those categories. For example, a musical artist producing ⅔ of his works in genre 1 and ⅓ of his works in genre 2 would have a profile reflecting a corresponding weighted membership in categories representing the genres. Moreover, the recommender software system can generate a profile for an item comprising a collection of lower level items. For example, a profile for a musical offering (e.g., a concert or recording) comprising a number of different musical artists can be generated based on the artists' profiles and/or the categories of musical selections presented by the artists.

The recommender software system 108 compares the user profile vectors to the domain item profile vectors, and ranks domain items according to the similarity between the user profile and the item profile. User recommendations can be based on the relative similarities. Similarity of user profile vectors to item profile vectors may be determined by any method known in the art, for example, computing the inner product of the vectors.

FIG. 2 shows an exemplary comparison of three domain items in accordance with various embodiments. The example of FIG. 200 illustrates three musical artists 202, 204, 206, wherein each artist corresponds to various musical genres as determined by the domain data 112, and no genre is shared by any two artists. As explained above, domain data 112 has been reorganized and a low-rank approximation algorithm applied to generate a short vector representation of each category (e.g., a musical genre). A profile generated for each artist is based on the categories to which an artist belongs. Some embodiments of the recommender software system 108 determine the similarity of one item to another by computing the similarity of each attribute of the item to the attributes of another item. Here, the similarities of each musical genre attributed to artists being compared can be computed. For example, the computed similarity of European Classical Music and Heavy Metal may be negative (e.g., −0.2140) in some embodiments, while the similarity between alternative metal and heavy metal may be positive (e.g., 0.0718), and the similarity between alternative rock and hard rock may also be positive (e.g., 0.1440). Aggregation of similarities computed for the various category vectors provides a measure of item similarity. Thus, as shown in FIG. 2, Artist 1 202 may exhibit greater similarity to Artist 2 204 than Artist 3 206 exhibits to either Artist 1 or Artist 2. Consequently, if a user profile includes category vectors corresponding to Artist 1 202, Artist 2 204 may be a better recommendation than Artist 3 206.

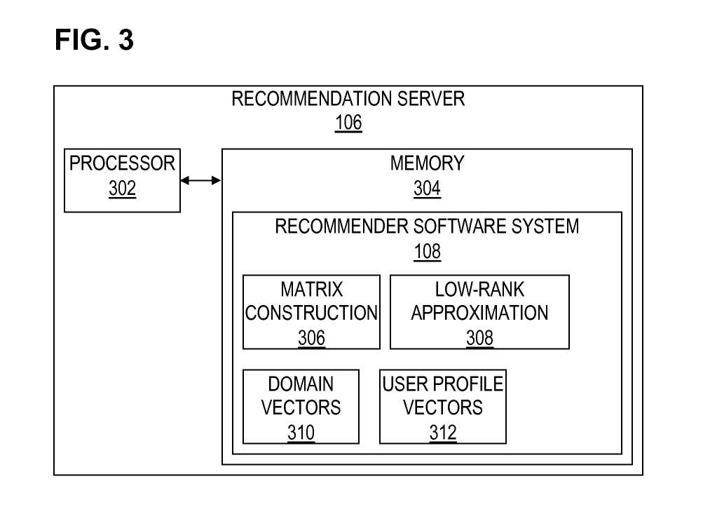

FIG. 3 shows a block diagram of the recommendation server 106 in accordance with various embodiments. The recommendation server 106 includes a processor 302 and memory 304. The processor 302 executes program instructions provided from a computer readable medium, such as memory 304. Embodiments of the processor 302 can include execution units (e.g., integer, fixed point, floating point, etc.), instruction decoders, storage units (e.g., memory, registers, etc.), input/output sub-systems (e.g., bus interfaces), peripherals (e.g., timers, interrupt controllers, direct memory access controllers, etc.), interconnecting buses, etc.

The memory 304 provides data and program storage for the processor 104 and other server 106 sub-systems. Exemplary memory technologies include various types of semiconductor random access memory (“RAM”), such as, dynamic RAM, static RAM, FLASH memory, etc.

The server 106 can include various other sub-systems, for example, secondary storage devices (e.g., hard disk, optical disk, etc.), input/output device (displays, keyboards, etc.), communication interfaces (network adapters, Universal Serial Bus, etc), expansion buses, etc.

As mentioned above, software programming can be provided to the processor 302 via a computer-readable medium. Exemplary computer-readable media include semiconductor memory, magnetic storage devices, optical storage devices, and other tangible media capable of storing processor executable software programming.

The memory 304 is configured to store the recommender software system 108. The recommender software system 108 includes matrix construction module 306 and low-rank approximation module 308. The matrix construction module 306 constructs the N×M binary domain matrix A that defines the relationships of the domain items and the domain categories. The low-rank approximation module 308 derives from the domain matrix A, a matrix of lower rank k that approximates the matrix A. This lower-rank matrix provides a compact representation of the domain, while reducing noise present in the domain matrix A. The k-dimensional vectors produced by the low-rank approximation module are stored as the domain vectors 310. The domain vectors 310 can also include, for each domain item, a profile based on the weighted membership of each item to each domain category.

In some embodiments, a user profile is stored in the recommendation server 106 as the user profile vectors 312. The user profile vectors are of dimension k and may be generated in the recommendation server 106 based on user data transferred from the user computer 102, or computed in the user computer 102 and transferred to the recommendation server 106. The user profile vectors 312 may be associated with a particular user via identification information derived from the user, for example, media access controller address or other hardware identification related to the user computer 102, user provided profile names, unique profile agent identification, etc. In any case, the user profile vectors are compared to the domain vectors to determine a set of domain items most closely related to the user profile for recommendation to the user.

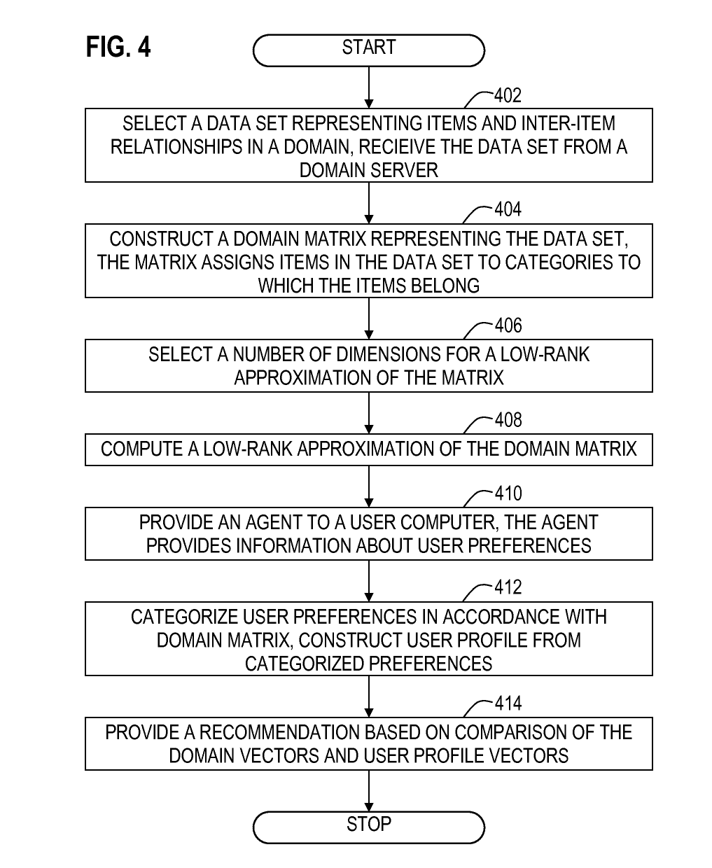

FIG. 4 shows a flow diagram for a method for providing recommendations to a user in accordance with various embodiments. Though depicted sequentially as a matter of convenience, some of the actions shown can be performed in a different order and/or performed in parallel. Additionally, some embodiments may perform only some of the actions shown. Some of the operations shown in FIG. 4 can be implemented via software programming stored in a computer-readable medium and executed by a processor.

In block 402, a data set 112 (i.e., domain data) representing items of a given domain, and the relationships between items in the domain is selected. The data set 112 is transferred from a domain server 110 to a recommendation server 106. A recommender software system 108 executing on the recommendation server 106 receives the data set 112 from the domain server 110.

In block 404, the recommender software system 108 constructs an N×M binary domain matrix that represents the data set 112. In the domain matrix, items in the data set 112 are assigned to data set 112 categories to which the items belong.

In block 406, a number of dimensions k are selected. The pre-selected number of dimensions k specifies the desired rank of a lower-rank matrix derived from the domain matrix.

In block 408, the recommender software system 108 applies a low-rank approximation algorithm to the domain matrix, resulting in a matrix of rank k that approximates the domain matrix, but with reduced noise and in a more compact form. The recommender software system 108 can generate a profile for a domain item based on a short vector representation of each category to which the item belongs.

In block 410, a profile agent 114 is provided to the user computer 114. In some embodiments, the recommender software system 108 provides the profile agent 114. In other embodiments, the profile agent 114 is provided to the user computer 102 from a different source. The profile agent 114 records information indicative of preferences of a user of the user computer 102. The preference information can include computer use history, such as browsing, purchasing, listening, or viewing history, or relevant information stored on the computer, such as play lists.

In block 412, the user preference information recorded by the profile agent 114 is categorized in accordance with the domain categories included in the domain matrix. The domain vectors 310, resulting from the application of the low-rank approximation algorithm to the domain matrix, which correspond to the user profile categories are combined to create a user profile (i.e., a set of user profile vectors 312) for the given domain. In some embodiments, the profile agent 114 transfers the user preference information to the recommender software system 108, and the recommender software system 108 constructs the user profile. In other embodiments, the profile agent 114 constructs the user profile and transfers the user profile vectors 312 to the recommender software system 108.

In block 414, the recommender software system 108 determines similarity of the user profile vectors 312 to the domain vectors 310 (e.g., the item profile vectors). Items corresponding to the domain vectors 310 most similar to the user profile vectors 312 are provided to the user as recommendations.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. A personalization system, comprising:
a processor; and
a software system executed by the processor;
wherein the software system provides a recommendation for an item, the recommendation based on a comparison of a low-rank approximation of a domain matrix to a user profile, the user profile based, in part, on the low-rank approximation of the domain matrix.

2. The system of claim 1 wherein the software system computes the low-rank approximation of the domain matrix, the approximation having a pre-selected number of dimensions.

3. The system claim 1, wherein the software system constructs the domain matrix from a domain data set received from a domain storage system, the matrix includes the items in the domain data set and assigns the items to categories to which the items belong as specified by the domain data set.

4. The system of claim 1, wherein the software system constructs the domain matrix as a matrix of binary values, each binary value defining a relation of an item of a domain data set to a category of the domain data set.

5. The system of claim 1, wherein the software system provides an agent for execution on a user computer, the agent provides to the software system information about a preference of the user based on information stored on the user computer and operations performed by the user computer, the preference information corresponds to a domain defined by the domain matrix.

6. The system of claim 5, wherein the agent categorizes the user preference information in accordance with the domain matrix constructed by the software system; and the agent constructs a user profile based, in part, on the low-rank approximation of the domain matrix.

7. The system of claim 5, wherein the software system receives the user profile from the agent, and determines similarity of a vector of the profile to vectors of the low-rank approximation of the domain matrix.

8. The system of claim 5, wherein the software system categorizes the user preference information in accordance with the domain matrix constructed by the software system, constructs a user profile based, in part, on the low-rank approximation of the domain matrix, and determines similarity of a vector of the profile vectors to vectors of the low-rank approximation of the domain matrix.

9. A computer readable medium encoded with a computer program, the computer program comprising:
instructions that when executed by a processor compute a low-rank approximation of a matrix representing a domain data set, the approximation matrix having a pre-selected number of dimensions; and
instructions that when executed by a processor provide a recommendation for an item, the recommendation based on similarity of the low-rank approximation of the matrix representing the domain data set to a user profile based, in part, on the low-rank approximation of the matrix representing the domain data set.

10. The computer readable medium of claim 9, further comprising instructions that when executed by a processor construct the matrix representing the domain data set, the matrix includes items in the domain data set and assigns the items to domain categories to which the items belong as specified by the domain data set.

11. The computer readable medium of claim 9, further comprising instructions that when executed by a processor construct the matrix representing the domain data set as a matrix of binary values, each binary value defining a relation of an item of the domain data set to a category of the domain data set.

12. The computer readable medium of claim 9, further comprising instructions that when executed by a processor provide an agent for execution on a user computer, the agent provides information about a preference of a user based on information stored on the user computer and operations performed by the user computer.

13. The computer readable medium of claim 9, further comprising:
instructions that when executed by a processor categorize user preference information in accordance with the matrix representing the domain data set; and
instructions that when executed by a processor construct a user profile based, in part, on the categorized user preference information and the low-rank approximation of the matrix representing the domain data set.

14. The computer readable medium of claim 9, further comprising instructions that when executed by a processor receive, from a user computer, a user profile based on the low-rank approximation of the matrix representing the domain data set, and determine similarity of a vector of the profile to vectors of the low-rank approximation of the domain matrix.

15. The computer readable medium of claim 9, further comprising:
instructions that when executed by a processor generate a profile for an item of the domain data set, the profile based on the low-rank approximation of the matrix representing the domain data set; and
instructions that when executed by a processor generate a profile for an item comprising a plurality of items of the domain data set, the profile based on the low-rank approximation of the matrix representing the domain data set.

16. A method, comprising:
computing, by a processor, a low-rank approximation of a matrix representing a domain data set, the approximation matrix having a pre-selected number of dimensions;
providing a recommendation for an item, via a processor, the recommendation based on a comparison of the low-rank approximation of the matrix representing the domain data set to a user profile based, in part, on the low-rank approximation of the matrix representing the domain data set.

17. The method of claim 16, further comprising:
selecting the domain data set, wherein the domain data set represents items and relationships between items in a selected domain;
constructing, by a processor, the matrix representing the domain data set, the matrix includes the items in the domain data set and assigns the items to categories to which the items belong as specified by the domain data set; and
selecting a number of dimensions for the low-rank approximation of the matrix representing the domain data set.

18. The method of claim 17, further comprising constructing the matrix representing the domain data set as a matrix of binary values, each binary value defining a relation of an item of the domain data set to a category of the domain data set.

19. The method of claim 16, further comprising providing an agent for execution on a user computer, the agent provides information about a preference of a user based on information stored on the user computer and operations performed by the user computer.

20. The method of claim 16, further comprising:
categorizing user preference information in accordance with the matrix representing the domain data set; and
constructing a user profile based, in part, on the categorized user preference information and the low-rank approximation of the matrix representing the domain data set.
